(19) United States
(12) Patent Application Publication
(10) Pub. No.: US 2026/0017789 A1
(43) Pub. Date: Jan. 15, 2026

(54) DEEP LEARNING-BASED MULTIMODAL IMAGE FUSION METHOD FOR SOFT TISSUE PHOTOACOUSTIC/ULTRASOUND IMAGING

(71) Applicants: HARBIN INSTITUTE OF TECHNOLOGY, Harbin (CN); HARBIN INSTITUTE OF TECHNOLOGY SUZHOU RESEARCH INSTITUTE, Suzhou (CN)

(72) Inventors: Mingjian SUN, Weihai (CN); Boheng ZHANG, Harbin (CN); Haorui HUANG, Harbin (CN); Yi SHEN, Harbin (CN)

(21) Appl. No.: 19/337,004

(22) Filed: Sep. 23, 2025

Related U.S. Application Data
(63) Continuation of application No. PCT/CN2024/122812, filed on Sep. 30, 2024.

(30) Foreign Application Priority Data
Apr. 19, 2024 (CN) 202410478090.9

(51) Int. Cl. G06T 7/00

(52) U.S. Cl. CPC G06T 7/0012; G06T 2207/10024; G06T 2207/10132; G06T 2207/20084; G06T 2207/20221

(57) ABSTRACT

The invention discloses a deep learning-based multimodal image fusion method for soft tissue photoacoustic/ultrasound imaging. Steps: an ultrasound-photoacoustic imaging device acquires photoacoustic and ultrasound images of human soft tissue and performs size normalization processing; an input spatial transformation module converts the images to the YCbCr space; an input pre-convolution module modifies the number of data channels; an input multi-scale feature extraction module extracts salient features from the source images; an input filter prediction module derives multi-scale filters; and an input filter fusion and adaptive enhancement module combines the input source images to obtain the final fused result. The invention has superior fusion performance compared to several traditional fusion methods and deep learning-based fusion methods, and more importantly, it exhibits excellent real-time performance. Furthermore, various modes of photoacoustic/ultrasound fusion extension experiments have verified the effectiveness of the method proposed in the invention.

### CROSS-REFERENCE TO RELATED APPLICATIONS

This application is a continuation of International Application No. PCT/CN2024/122812, filed on Sep. 30, 2024, which claims priority to Chinese Patent Application No. 202410478090.9, filed on Apr. 19, 2024, both of which are hereby incorporated by reference in their entireties.

### TECHNICAL FIELD

The present invention relates to a multimodal medical image fusion method, specifically an unsupervised multimodal image fusion method for human soft tissue photoacoustic/ultrasound imaging based on multi-channel filtering and adaptive enhancement.

### BACKGROUND TECHNOLOGY

In recent years, various medical imaging techniques have been widely applied in the diagnosis of diseases. Generally speaking, relying on a single imaging modality is insufficient to obtain comprehensive diagnostic information, which is crucial for ensuring the accuracy and comprehensiveness of diagnosis. Therefore, the method of multimodal medical image fusion combines data from different imaging modalities to form comprehensive images rich in information, providing a solid basis for clinical diagnosis. Multimodal medical image fusion technology integrates images from various sources such as X-rays, Computed Tomography (CT), Single-Photon Emission Computed Tomography (SPECT), Ultrasound (US), Magnetic Resonance Imaging (MRI), infrared rays, ultraviolet rays, and Positron Emission Tomography (PET).

Imaging techniques such as MRI, X-ray, CT, and US can reveal the location, size, and morphology of lesions, as well as their impact on surrounding tissue structures. However, to further explore the biological characteristics, soft tissue status, and functional information of tumors, the application of Positron Emission Computed Tomography, Functional Magnetic Resonance Imaging, and Single-Photon Emission Computed Tomography is becoming increasingly common. By combining functional and structural data, medical image fusion can generate more valuable diagnostic information. In the process of treating specific human organs, medical image fusion plays a key role, enabling more precise monitoring and analysis of diseases.

Among these, ultrasound imaging and photoacoustic imaging technologies have been widely applied in the medical field, particularly in the imaging of human soft tissues. Each of these two imaging technologies have their unique advantages, and their combination can provide more comprehensive and in-depth diagnostic information, which is of great significance for clinical diagnosis and treatment. Ultrasound imaging utilizes high-frequency sound waves to detect internal body structures. The echoes generated by sound waves at the interfaces of different tissue are converted into images, enabling real-time display of dynamic changes inside the body. The advantages of this technology lie in its radiation-free risk, real-time imaging capability, portability, and cost-effectiveness, particularly for the observation of soft tissue structures. However, it has certain limitations in resolution and depth, especially in the imaging of bones and gaseous tissues. Photoacoustic imaging combines the advantages of optics and acoustics: it uses laser pulses to induce thermal expansion of tissues, which generates ultrasound waves for imaging. This technology is known for its high contrast and deep tissue imaging capabilities, especially suitable for the imaging of blood vessels and hemoglobin-rich tissues. Although photoacoustic imaging has certain limitations in imaging depth and equipment requirements, it has significant advantages in resolution. Fusing ultrasound images with photoacoustic images enables complementarity, enhancing the accuracy and information richness of human soft tissue imaging. This fusion technology combines the real-time monitoring capability of ultrasound imaging with the high contrast and high resolution characteristics of photoacoustic imaging, enabling more detailed and in-depth observation of soft tissues and surrounding blood vessels.

The challenge in fusing ultrasonic and photoacoustic image lies in retaining as much feature information of different modal images as possible. Currently, the primary fusion methods include traditional methods and deep learning-based methods. The fusion process of traditional methods can be summarized as follows: first, decompose the input images in the frequency or spatial domain; second, design specific fusion rules based on the decomposed components; finally, reconstruct the images the using the fused component information according to the previous decomposition method, to obtain the fused multimodal medical images. Therefore, traditional fusion methods are limited by the complexity of image decomposition, usually requiring significant computational resources, and manually designed fusion rules can easily affect fusion efficiency and effectiveness. In recent years, deep learning has become increasingly prevalent in the field of computer vision, and extensive research has been conducted on its application in image fusion. However, for multimodal medical image fusion, due to the lack of standard fusion results and a large number of safe and reliable medical images, supervised deep learning methods are difficult to implement. Therefore, it is particularly important to balance the generalization ability and accuracy of the model in unsupervised training. Currently, unsupervised deep learning-based fusion methods are mainly divided into two categories: weight map-based fusion methods and deep representation-based fusion methods. Among them, weight map-based fusion methods first obtain corresponding weight maps from source images through the same neural network, and then perform weighted fusion based on the weight maps and source images to obtain the fused image. Deep representation-based fusion methods first process different source images through corresponding neural networks, obtain fused feature maps according to fusion rules, and then further process these feature maps using deep neural networks to generate the final fused image. However, weight map-based fusion methods lack consideration for local information and spatial continuity of the input images. Deep representation-based fusion methods are more difficult to balance the relationship between network depth and fusion effectiveness. How to balance the high quality of fusion results and the lightweight of network structure is an important challenge in image fusion tasks. In addition, due to the lack of true labels in image fusion tasks, a comprehensive loss function that considers image pixel intensity, feature information, structural information, and correlation is highly valuable to ensure the preservation of fused information during unsupervised fusion network training.

### SUMMARY OF THE INVENTION

To address the problems of poor fusion performance, high time computation of the multimodal image fusion algorithm for human soft tissue photoacoustic/ultrasound imaging, and the lack of a loss function capable of comprehensively evaluating the fusion performance, the present invention proposes a deep learning-based multimodal image fusion method for soft tissue photoacoustic/ultrasound imaging.

The objective of the present invention is achieved through the following technical solutions:

A deep learning-based multimodal image fusion method for soft tissue photoacoustic/ultrasound imaging, comprising the following steps:
step (1): obtain ultrasound and photoacoustic source images of human soft tissue from an ultrasound-photoacoustic multimodal imaging device, and preprocess the source images through size normalization;
step (2): convert the preprocessed source images from RGB space to YCbCr space through a channel-space conversion module; further input the data of the three channels into a pre-convolution module, which restructures the data of each channel in the channel dimension;
step (3): input the image processed by the pre-convolution module into a multi-scale feature extraction module; the encoding stage of the multi-scale feature extraction module comprises two encoding layers, the operation of the first encoding layer is expressed as follows:

$${x}_{11} = ResBlock ( {x}_{n} )$$

$${x}_{down 1} = {Skip}_{Conv} ( \text{} Concat ( {x}_{n} , HybridAttention ( Down ( {x}_{11} ) ) ) , HybridAttention ( Down ( {x}_{11} ) ) )$$

where xₙ represents the image processed by the pre-convolution module, ResBlock(⋅) denotes a residual operation, HybridAttention(⋅) represents a hybrid attention operation, Skip_{Conv}(⋅) denotes a skip operation with convolution applied, Down(⋅) denotes a downsampling operation, and Concat(⋅) denotes the concatenation operation;

the operation of the second encoding layer is expressed as follows:

$${x}_{12} = ResBlock ( {x}_{down 1} )$$

$${x}_{down 2}^{′} = {Skip}_{Conv} ( \text{} Concat ( {x}_{down 1} , HybridAttention ( Down ( {x}_{12} ) ) ) , HybridAttention ( Down ( {x}_{12} ) ) )$$

$${x}_{down 2} = {Skip}_{Conv} ( \text{} Concat ( {x}_{n} , {x}_{down 2}^{′} ) , {x}_{down 2}^{′} )$$

$${x}_{bottom} = ResBlock ( {x}_{down 2} )$$

where x_{bottom} denotes the bottom-layer output of the encoding stage;

the bottom-layer output generates features of different scales through two decoding operations, and the specific process is expressed as follows:

$${x}_{up 1} = {Skip}_{Conv} ( \text{} Concat ( {x}_{bottom} , HybridAttention ( Up ( {x}_{bottom} ) ) ) , HybridAttention ( Up ( {x}_{bottom} ) ) )$$

$${x}_{21} = {Skip}_{Res} ( \text{} Concat ( {x}_{12} , ResBlock ( {x}_{up 1} ) ) , ResBlock ( {x}_{up 1} ) )$$

$${x}_{up 2} = {Skip}_{Conv} ( \text{} Concat ( {x}_{21} , HybridAttention ( Up ( {x}_{21} ) ) ) , HybridAttention ( Up ( {x}_{21} ) ) )$$

$${x}_{22}^{′} = {Skip}_{Conv} ( \text{} Concat ( {x}_{bottom} , ResBlock ( {x}_{up 2} ) ) , ResBlock ( {x}_{up 2} ) )$$

$${x}_{22} = {Skip}_{Res} ( \text{} Concat ( {x}_{11} , {x}_{22}^{′} ) , {x}_{22}^{′} )$$

where x₂₁ and x₂₂ are two feature outputs of different scales in decoding process, Skip_{Res}(⋅) represents the Skip operation with residual applied, and Up(⋅) represents the upsampling operation;

after processing by the multi-scale feature extraction module, the source image yields three features, which are

$${F}_{n}^{2} = {x}_{22} , {F}_{n}^{1} = {x}_{21} , and {F}_{n}^{0} = {x}_{bottom}$$

in descending order of size;
step (4): combine features of three different scales corresponding to the Y, Cb, and Cr channels in pairs and input into a filter prediction module; the filter prediction module employs spatial cross-attention to dynamically process two input feature maps

$${F}_{0}^{m} and {F}_{1}^{m}$$

at the same scale simultaneously, and assigns weights based on the importance of each position, thereby outputting the corresponding spatially attention-weighted feature maps; the specific operation is expressed as follows:

$$A = [ {A}_{0} , {A}_{1} ] = Sigmoid ( Conv ( ReLU ( Conv ( Concat ( {F}_{0}^{m} , {F}_{1}^{m} ) ) ) ) )$$

$$[ {F}_{0}^{m ′} , {F}_{1}^{m} ] = [ {F}_{0}^{m} ▯ {A}_{r} , {F}_{1}^{m} ▯ {A}_{1} ]$$

Where A is the attention weight, A₀ and A₁ correspond to the weight components of

$${F}_{0}^{m} and {F}_{1}^{m} , {F}_{0}^{m ′} and {F}_{1}^{m ′}$$

represent the spatially attention-weighted feature map corresponding to the input feature map

$${F}_{0}^{m} and {F}_{1}^{m} ,$$

m=0,1,2 denotes the sequence number of different scales, [symbol] represents the Hadamard product, Sigmoid(⋅) denotes the Sigmoid activation function, and ReLU(⋅) denotes the ReLU activation function;

the spatially attention-weighted feature map

$${F}_{0}^{m ′} and {F}_{1}^{m ′}$$

and the corresponding source image are inputted into a kernel prediction network based on a residual structure, respectively; during learning, the network predicts the most effective filter

$${Filter}_{0}^{m} and {Filter}_{1}^{m}$$

through dynamic changes of

$${F}_{0}^{m ′} and {F}_{1}^{m ′} ,$$

the specific prediction operation of filter is expressed as follows:

$${k}_{n}^{m} = Conv ( ReLU ( Conv ( Resblock ( {F}_{n}^{m ′} ) ) ) )$$

$${Filter}_{n}^{m} = fold ( sum ( {k}_{n}^{m} \cdot Unfold ( {x}_{n} ) ) )$$

where Unfold(⋅) denotes the conversion of the source image into a column vector, fold(⋅) denotes the reshaping of the feature map to its original size, sum(⋅) denotes the summation operation,

$${k}_{n}^{m}$$

represents the predicted convolutional kernel weight corresponding to

$${F}_{n}^{m ′} ;$$

the filter at the current scale Filter^{m}∈2×C×W×k² is obtained by adding the two filters, as shown in the following equation:

$${Filter}^{m} = {Filter}_{0}^{m} + {Fllter}_{1}^{m}$$

step (5): input the Y, Cb, and Cr channel data of the two source images and filters of three different kernel sizes into a filtering fusion and adaptive enhancement module for convolution operations, and perform a weighted summation of the obtained convolution results to generate the fused Y, Cb, and Cr channel data, as shown in the following formula:

$${I}_{Y - fuse} = {\sum }_{i = 0}^{2} {a}_{0 , i} ( {Filter}_{Y}^{i} ⊗ Concat ( {I}_{Y - 0} , {I}_{Y - 1} ) )$$

$${I}_{Cb - fuse} = {\sum }_{i = 0}^{2} {a}_{1 , i} ( {Filter}_{Cb}^{i} ⊗ Concat ( {I}_{Cb 0} , {I}_{Cb 1} ) )$$

$${I}_{Cr - fuse} = {\sum }_{i = 0}^{2} {a}_{2 , i} ( {Filter}_{Cr}^{i} ⊗ Concat ( {I}_{Cr - 0} , {I}_{Cr - 1} ) )$$

where I_{Y-fuse}, C_{b-fuse} and I_{Cr-fuse} represent the fused results of the source image in the Y channel, Cb channel, and Cr channel; I_{Cb-0}, I_{Cb-1}, I_{Cr-0}, I_{Cr-1}, I_{Y-0}, and I_{Y-1} are the information of the YCbCr channels of the input source image; α is a training parameter in the network, ⊗ represents the convolution operation;
step (6): realize adaptive enhancement of the fused image by adjusting the brightness and contrast factors of the Y channel, as well as the saturation factors of the Cb and Cr channels during the training process, to realize adaptive enhancement of the fused image; output the enhanced data of the Y, Cb, and Cr channels and reconstruct to generate the fused result, thus realizing unsupervised fusion of human soft tissue photoacoustic/ultrasound multimodal images.

Compared to existing technologies, the present invention possesses the following advantages:
Quantitative and qualitative assessments on open-source CT-MRI images, MRI-PET images, MRI-SPECT images, and photoacoustic-ultrasound images demonstrate that the method proposed in the present invention exhibits superior fusion performance compared to several traditional fusion methods and deep learning-based fusion methods. More importantly, the present invention demonstrates excellent real-time performance. Furthermore, multiple modes of photoacoustic/ultrasound fusion extension experiments were conducted on a photoacoustic/ultrasound multimodal imaging system, verifying the effectiveness of the method proposed in the present invention.

### DESCRIPTION OF DRAWINGS

FIG. 1 shows a flow chart of an unsupervised multimodal image fusion method for human soft tissue photoacoustic/ultrasound imaging based on multi-channel filtering and adaptive enhancement;

FIG. 2 shows a framework of an unsupervised multimodal image fusion method for human soft tissue photoacoustic/ultrasound imaging based on multi-channel filtering and adaptive enhancement;

FIG. 3 shows a framework of the multi-scale feature extraction module;

FIG. 4 shows a structural framework of hybrid attention;

FIG. 5 shows a framework of the filter prediction module;

FIG. 6 shows a framework of the filtering fusion and adaptive enhancement module;

FIG. 7 shows the photoacoustic ultrasound fusion imaging effect of human soft tissue and the corresponding histograms.

### EMBODIMENT

The technical solution of the present invention will be further described below with reference to drawings, but is not limited thereto. Any modification or equivalent replacement to the technical solution of the present invention without departing from the spirit and scope of the technical solution should be included in the protection scope of the present invention.

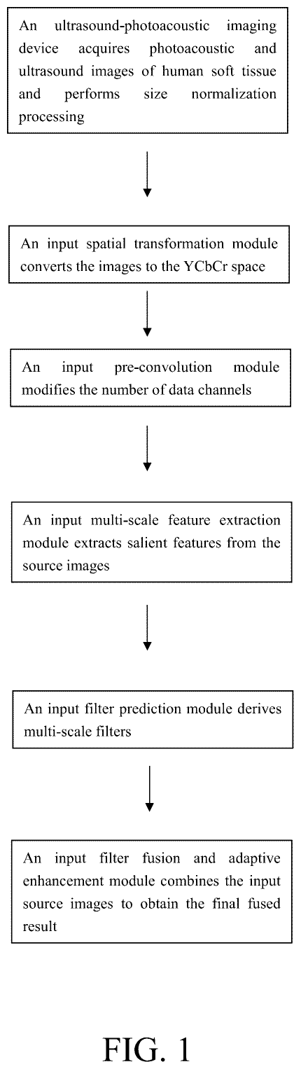

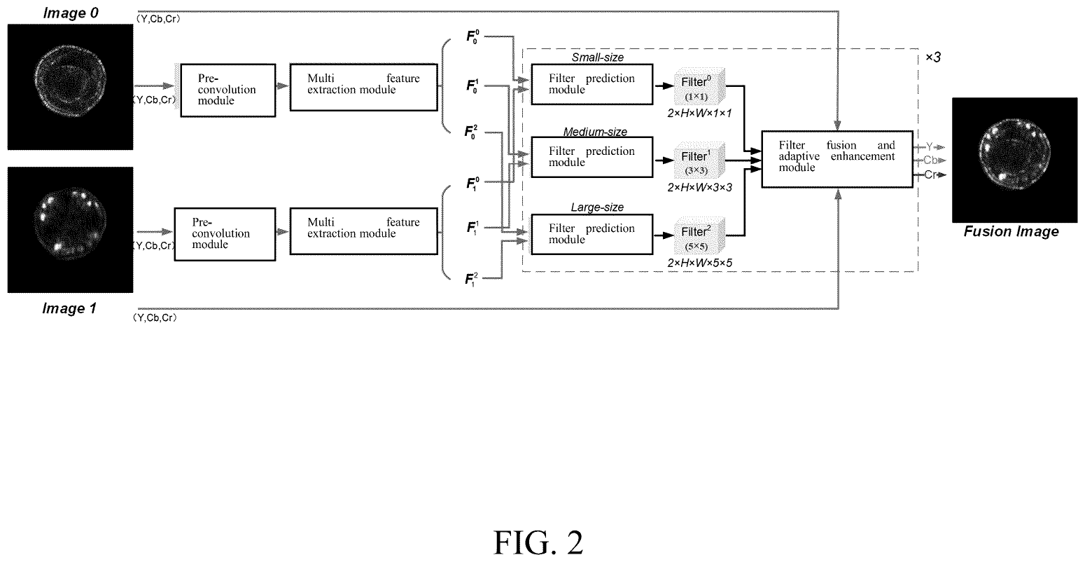

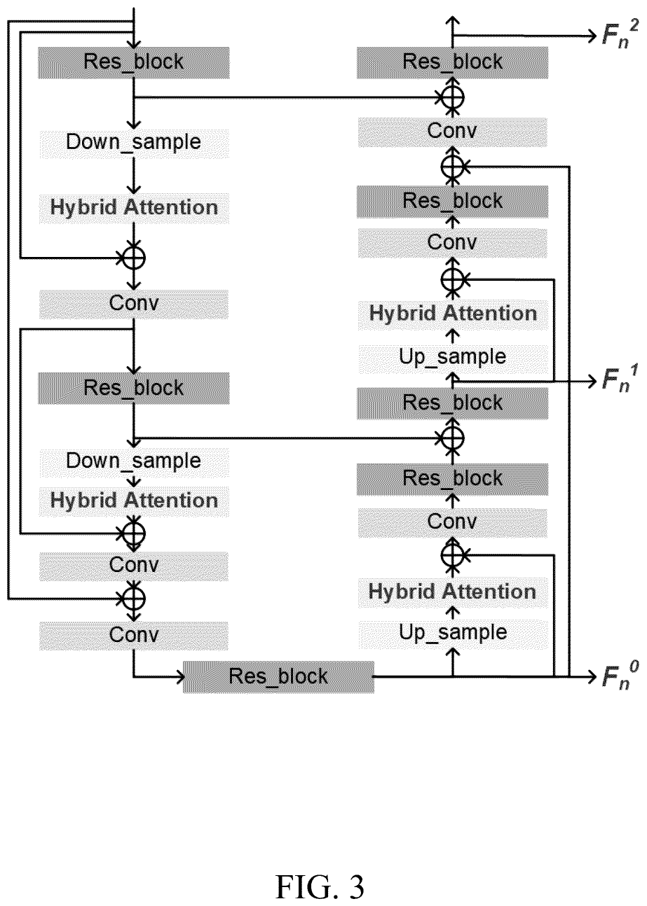

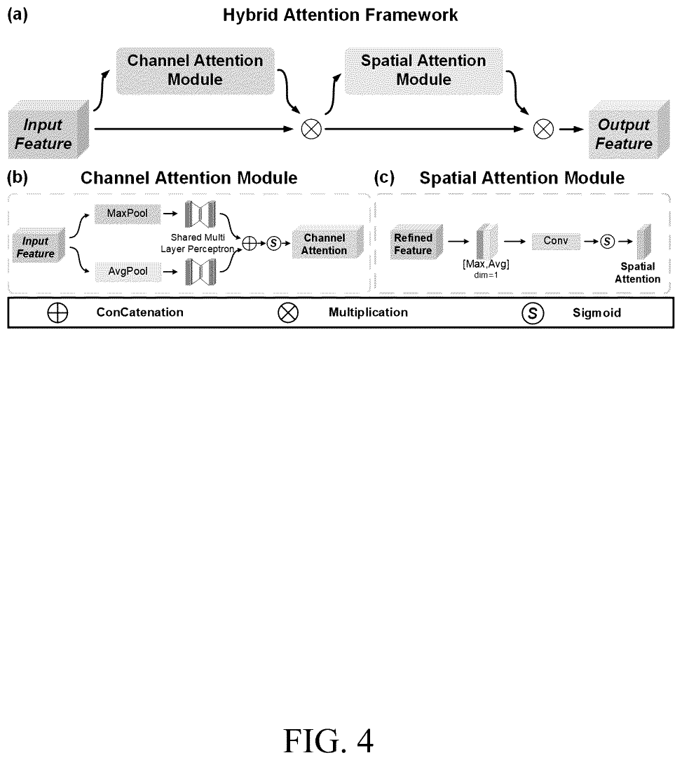

This invention presents a deep learning-based multimodal image fusion method for photoacoustic/ultrasound imaging. As illustrated in FIG. 1, the method comprises the following steps: an ultrasound-photoacoustic imaging device acquires photoacoustic and ultrasound images of human soft tissue and performs size normalization processing; an input spatial transformation module converts the images to the YCbCr space; an input pre-convolution module modifies the number of data channels; an input multi-scale feature extraction module extracts salient features from the source images; an input filter prediction module derives multi-scale filters; and an input filter fusion and adaptive enhancement module combines the input source images to obtain the final fused result. As depicted in FIG. 2, the specific steps are as follows:
Step (1): obtain ultrasound and photoacoustic source images of human soft tissue from an ultrasound-photoacoustic multimodal imaging device, and preprocess the source images through size normalization.
Step (2), convert the preprocessed source images from RGB space to YCbCr space through a channel-space conversion module; further input the data from the three channels into a pre-convolution module, which restructures the data for each channel in the channel dimension.
Step (3): input the image processed by the pre-convolution module into a multi-scale feature extraction module. The multi-scale feature extraction module is designed to extract salient features that can represent the source image. The multi-scale feature extraction module is mainly composed of a residual block, a convolution block, and a hybrid attention block, with the specific structure shown in FIG. 3. Compared to UNet, this module incorporates a hybrid attention mechanism and a residual structure, and incorporates learnable parameters to the basic skip operation to adaptively balance encoding and decoding features. These optimizations effectively enhance the ability of the network to process and extract different scale without increasing complexity. Considering the balance between model performance and complexity, the encoding stage of the multi-scale feature extraction module proposed in the present invention includes two encoding layers. The operation of the first encoding layer encoding is shown in Equation (1):

$${x}_{11} = ResBlock ( {x}_{n} ) \qquad ( 1 )$$

$${x}_{down 1} = {Skip}_{Conv} ( Concat ( {x}_{n} , HybridAttention ( Down ( {x}_{11} ) ) ) , HybridAttention ( Down ( {x}_{11} ) ) )$$

Where ResBlock(⋅) represents a residual operation, including two convolutional layers, instance normalization, LeakyReLU function activation, and a residual connection. HybridAttention(⋅) signifies a hybrid attention operation, utilizing a convolutional block attention module that incorporates both channel attention and spatial attention. The role of channel attention is to establish correlations between different channels, automatically assigning different weights based on the importance of channels through network learning, thereby enhancing important features and suppressing non-important features. The role of spatial attention is to enhance the feature representation of key regions by transforming spatial information in the feature map to another space and generating weighted masks based on the importance of different locations, thus enhancing regions of interest and suppressing irrelevant regions. The structure of hybrid attention is shown in FIG. 4. The input feature map first passes through channel attention and than spatial attention. Skip_{Conv}(⋅) denotes a skip operation with convolution applied. Down(⋅) denotes a downsampling operation. Then, the bottom output is obtained through the operation of the second encoding layer as shown in Equation (2):

$${x}_{12} = ResBlock ( {x}_{down 1} ) \qquad ( 2 )$$

$${x}_{down 2}^{′} = {Skip}_{Conv} ( Concat ( {x}_{down 1} , HybridAttention ( Down ( {x}_{12} ) ) ) , HybridAttention ( Down ( {x}_{12} ) ) )$$

$${x}_{down 2} = {Skip}_{Conv} ( Concat ( {x}_{n} , {x}_{down 2}^{′} ) , {x}_{down 2}^{′} )$$

$${x}_{bottom} = ResBlock ( {x}_{down 2} )$$

Where x_{bottom} is the bottom-layer output of the encoding stage. Then, the bottom-layer output needs to be processed through two decoding operations to output features of different scales. The specific process is shown in formula (3):

$${x}_{up 1} = {Skip}_{Conv} ( Concat ( {x}_{bottom} , HybridAttention ( Up ( {x}_{bottom} ) ) ) , HybridAttention ( Up ( {x}_{bottom} ) ) ) \\ {x}_{21} = {Skip}_{Res} ( Concat ( {x}_{12} , ResBlock ( {x}_{up 1} ) ) , ResBlock ( {x}_{up 1} ) ) \\ {x}_{up 2} = {Skip}_{Conv} ( Concat ( {x}_{21} , HybridAttention ( Up ( {x}_{21} ) ) ) , HybridAttention ( Up ( {x}_{21} ) ) ) \\ {x}_{22}^{′} = {Skip}_{Conv} ( Concat ( {x}_{bottom} , ResBlock ( {x}_{up 2} ) ) , ResBlock ( {x}_{up 2} ) ) \\ {x}_{22} = {Skip}_{Res} ( Concat ( {x}_{11} , {x}_{22}^{′} ) \qquad ( 3 )$$

Where x₂₁ and x₂₂ are two feature outputs of different scales in decoding process. Skip_{Res}(⋅) represents the Skip operation with residual applied. Up(⋅) represents the upsampling operation. Finally, after processing by the multi-scale feature extraction module, the source image obtains three features, which are

$${F}_{n}^{2} = {x}_{22} , {F}_{n}^{1} = {x}_{21} , and {F}_{n}^{0} = {x}_{bottom}$$

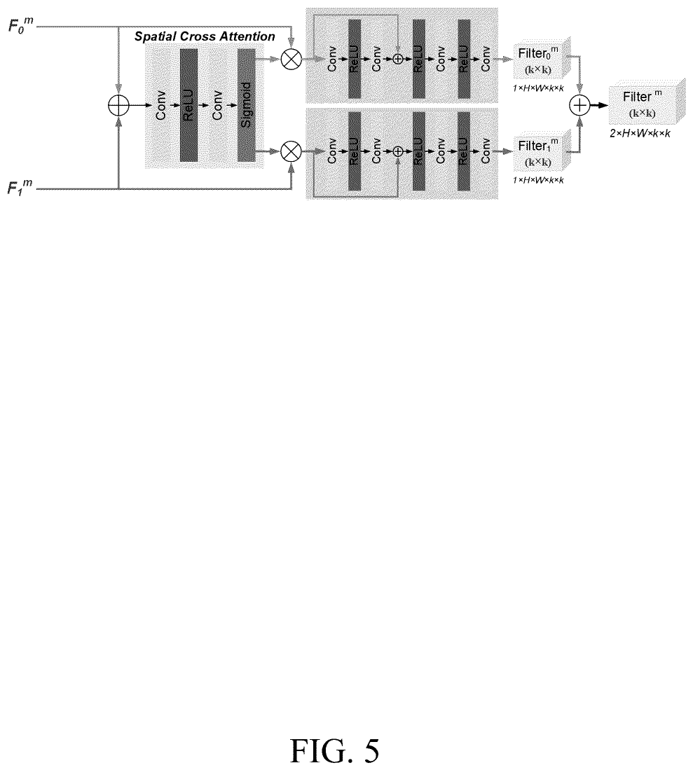

in descending order of size.
Step (4) refers to the principle of kernel prediction networks, combining features of three different scales corresponding to the Y, Cb, and Cr channels in pairs and inputting into a filter prediction module (FIG. 5). Through attention mechanism prediction, filters with different kernel sizes corresponding to different channels are obtained. The filter prediction module is a key part of the entire fusion network. The main task of this module is to utilize the three features of different scale obtained from the multi-scale feature extraction module to predict filters that guide image fusion. Since multimodal medical image fusion is a process that requires simultaneous consideration of complementary learning from different source images, the network has to perform cross-image operations during operation. The filter prediction module first adopts spatial cross-attention to dynamically process two input feature maps

$${F}_{0}^{m} and {F}_{1}^{m}$$

of the same scale simultaneously, and assigns weights according to the importance of each position, thereby outputing the corresponding spatially attention-weighted feature maps. The specific operation is shown in formula (4):

$$A = [ {A}_{0} , {A}_{1} ] = Sigmoid ( Conv ( Re LU ( Conv ( Concat ( {F}_{0}^{m} , {F}_{1}^{m} ) ) ) ) ) \\ [ {F}_{0}^{m ′} , {F}_{1}^{m ′} ] = [ {F}_{0}^{m} ▯ {A}_{0} , {F}_{1}^{m} ▯ {A}_{1} ] \qquad ( 4 )$$

where A represents the attention weight, A₀ and A₁ correspond to the weight components of

$${F}_{0}^{m} and {F}_{1}^{m} ,$$

respectively.

$${F}_{0}^{m ′} and {F}_{1}^{m ′}$$

represent the spatially attention-weighted feature map corresponding to the input feature map

$${F}_{0}^{m} and {F}_{1}^{m} .$$

m=0,1,2 is the sequence number of different scales. Then, the spatially attention-weighted feature map

$${F}_{0}^{m ′} and {F}_{1}^{m ′}$$

and the corresponding source image are input into a kernel prediction network based on a residual structure, respectively. During learning, the network predicts the most effective filters

$${Filter}_{0}^{m} and {Filter}_{1}^{m}$$

through dynamic changes of

$${F}_{0}^{m ′} and {F}_{1}^{m ′} .$$

To reduce the complexity of the model and enhance its performance, the present invention did not use a deep convolutional neural network to extract rich image features, but instead employed a kernel prediction network based on a residual structure. On the one hand, the residual structure enables the reuse of features between different layers, which improves network utilization while enhancing the generalization ability of features. On the other hand, for pixel-level operations, the residual structure can maintain the spatial resolution of the input features and retain part of the detailed information of the upper-layer features. The specific operation of filter prediction is shown in Equation (5):

$${k}_{n}^{m} = Conv ( Re LU ( Conv ( Resblock ( {F}_{n}^{m ′} \text{)} ) ) ) \\ {Filter}_{n}^{m} = fold ( {k}_{n}^{m} \cdot Unfold ( {x}_{n} ) ) ) \qquad ( 5 )$$

Where Unfold(⋅) denotes the conversion of the source image into a column vector, fold(⋅) denotes the reshaping of the feature map to its original size, sum(⋅) denotes the summation operation,

$${k}_{n}^{m}$$

represents the predicted convolutional kernel weight corresponding to

$${F}_{n}^{m ′} .$$

Finally, by adding these two filters, we obtain the filter for the current scale Filter^{m}∈2×C×W×k², as shown in Equation (6):

$${Filter}^{m} = {Fiter}_{0}^{m} + {Filter}_{1}^{m} \qquad ( 6 )$$

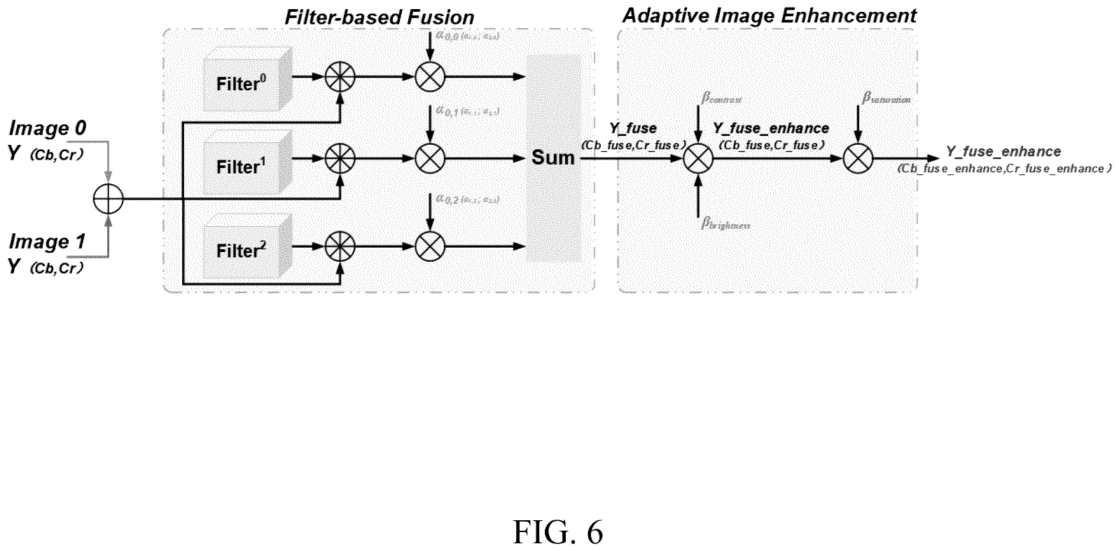

The predicted filter, combined with spatial cross-attention, enable adaptive processing for each position in the source image.
Step (5): input the Y, Cb, and Cr channel data of the two source images and filters of three different kernel sizes into a filtering fusion and adaptive enhancement module (FIG. 6) for convolution operations. The obtained convolution results are then weighted and summed to produce the fused Y, Cb, and Cr channel data, as shown in formula (7):

$$\begin{matrix}{I}_{Y - fuse} = {\sum }_{i = 0}^{2} {α}_{0 , i} ( {Filter}_{Y}^{i} ⊗ Concat ( {I}_{Y - 0} , {I}_{Y - 1} ) ) \\ {I}_{Cb - fu se} = {\sum }_{i = 0}^{2} {α}_{1 , i} ( {Filter}_{Cb}^{i} ⊗ Concat ( {I}_{Cb - 0} , {I}_{Cb - 1} ) ) \\ {I}_{Cr - fu se} = {\sum }_{i = 0}^{2} {α}_{2 , i} ( {Filter}_{Cr}^{i} ⊗ Concat ( {I}_{Cr - 0} , {I}_{Cr - 1} ) )\end{matrix} \qquad ( 7 )$$

Where I_{Y-fuse}, I_{Cb-fuse} and I_{Cr-fuse} represent the fused results of the source image in the Y channel, Cb channel, and Cr channel; α is a training parameter in the network.
Step (6): realize adaptive enhancement of the fused image by adjusting the brightness factor and contrast factor of the brightness (Y) channel, as well as the saturation factor of the color (Cb, Cr) channels during the training process; output the enhanced data of the Y, Cb, and Cr channels, and reconstruct to generate the fused result, thus realizing unsupervised fusion of human soft tissue photoacoustic/ultrasound multimodal images.

### EXAMPLE

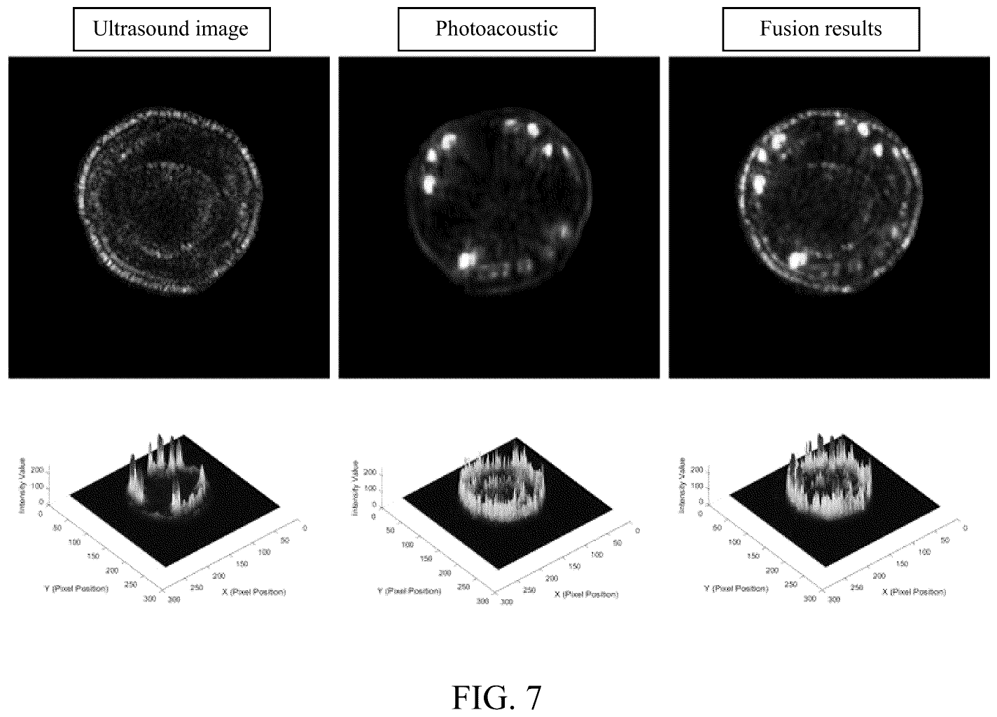

In this embodiment, real-time fusion imaging experiments were conducted on a photoacoustic-ultrasound imaging system. The human soft tissue ultrasound and photoacoustic multimodal images output by the imaging system were directly connected to the source image input interface of the fusion method. Through experimental testing, the multimodal fusion imaging speed of the entire system was 8FPS. The fusion imaging results and corresponding grayscale histograms are shown in FIG. 7, and the quantitative indicators compared with mainstream methods are presented in Table 1. The fusion results can clearly restore all detailed features and colors of the source images. Furthermore, as can be seen from the grayscale histogram, the method proposed in the present invention can also reduce the noise of photoacoustic and ultrasound images to a certain extent.

TABLE 1
Quantitative Metrics for Different Fusion Methods

| Metrics | NSCT | NSST-PAPCNN | CSMCA | CNN | NestFuse |
|---|---|---|---|---|---|
| SSIM ↑ | 0.955 ± 0.03 | 0.977 ± 0.02 | 0.968 ± 0.02 | 0.897 ± 0.10 | 0.913 ± 0.04 |
| MSE ↓ | 0.215 ± 0.06 | 0.190 ± 0.05 | 0.208 ± 0.03 | 0.265 ± 0.04 | 0.354 ± 0.05 |
| MI ↑ | 1.952 ± 0.21 | 1.970 ± 0.18 | 2.032 ± 0.14 | 1.916 ± 0.09 | 1.751 ± 0.05 |
| EN ↑ | 5.834 ± 0.03 | 5.968 ± 0.04 | 5.881 ± 0.06 | 6.628 ± 0.08 | 7.224 ± 0.13 |
| PSNR ↑ | 56.986 ± 4.19 | 57.201 ± 5.21 | 57.045 ± 6.12 | 57.056 ± 6.63 | 56.583 ± 6.52 |
| \|rSFe\| ↓ | 0.101 ± 0.02 | 0.155 ± 0.04 | 0.135 ± 0.01 | 0.205 ± 0.09 | 0.207 ± 0.08 |
| FMI ↑ | 0.401 ± 0.05 | 0.412 ± 0.04 | 0.419 ± 0.03 | 0.321 ± 0.12 | 0.500 ± 0.08 |
| Q^{AB/F} ↑ | 0.576 ± 0.02 | 0.581 ± 0.05 | 0.587 ± 0.07 | 0.462 ± 0.14 | 0.619 ± 0.03 |
| N^{AB/F} ↓ | 0.172 ± 0.01 | 0.155 ± 0.02 | 0.064 ± 0.03 | 0.042 ± 0.02 | 0.026 ± 0.02 |
| SCD ↑ | 1.083 ± 0.15 | 1.172 ± 0.21 | 1.196 ± 0.18 | 0.721 ± 0.34 | 1.382 ± 0.23 |
| Q_{S} ↑ | 0.796 ± 0.04 | 0.786 ± 0.06 | 0.942 ± 0.03 | 0.745 ± 0.14 | 0.886 ± 0.04 |
| VIFF ↑ | 0.732 ± 0.05 | 0.867 ± 0.02 | 0.431 ± 0.13 | 0.543 ± 0.02 | 0.406 ± 0.03 |

| Metrics | DDcGAN | CDRNet | IFCNN | U2Fusion | MFAE-Fusion |
|---|---|---|---|---|---|
| SSIM ↑ | 0.836 ± 0.09 | 0.971 ± 0.03 | 0.942 ± 0.05 | 0.932 ± 0.06 | 0.975 ± 0.02 |
| MSE ↓ | 0.325 ± 0.08 | 0.248 ± 0.04 | 0.288 ± 0.05 | 0.253 ± 0.03 | 0.126 ± 0.02 |
| MI ↑ | 1.683 ± 0.20 | 2.029 ± 0.11 | 1.886 ± 0.15 | 1.795 ± 0.18 | 2.083 ± 0.13 |
| EN ↑ | 6.724 ± 0.08 | 6.023 ± 0.11 | 7.106 ± 0.06 | 6.739 ± 0.04 | 6.806 ± 0.02 |
| PSNR ↑ | 56.932 ± 8.34 | 57.343 ± 6.86 | 57.265 ± 6.24 | 57.056 ± 5.34 | 57.214 ± 8.21 |
| \|rSFe\| ↓ | 0.145 ± 0.06 | 0.136 ± 0.03 | 0.096 ± 0.04 | 0.168 ± 0.07 | 0.125 ± 0.05 |
| FMI ↑ | 0.385 ± 0.06 | 0.609 ± 0.05 | 0.462 ± 0.06 | 0.416 ± 0.07 | 0.613 ± 0.04 |
| Q^{AB/F} ↑ | 0.588 ± 0.03 | 0.633 ± 0.02 | 0.618 ± 0.03 | 0.596 ± 0.03 | 0.626 ± 0.02 |
| N^{AB/F} ↓ | 0.108 ± 0.03 | 0.086 ± 0.03 | 0.101 ± 0.02 | 0.055 ± 0.02 | 0.024 ± 0.02 |
| SCD ↑ | 0.943 ± 0.43 | 1.406 ± 0.15 | 1.121 ± 0.22 | 1.482 ± 0.04 | 1.542 ± 0.04 |
| Q_{S} ↑ | 0.844 ± 0.06 | 0.881 ± 0.07 | 0.862 ± 0.06 | 0.856 ± 0.03 | 0.935 ± 0.05 |
| VIFF ↑ | 0.297 ± 0.13 | 0.470 ± 0.05 | 0.702 ± 0.07 | 0.827 ± 0.04 | 0.756 ± 0.04 |

What is claimed is:

1. A deep learning-based multimodal image fusion method for soft tissue photoacoustic/ultrasound imaging, characterized in that, the method comprises the following steps:
step (1): obtain ultrasound and photoacoustic source images of human soft tissue from an ultrasound-photoacoustic multimodal imaging device, and preprocess the source images through size normalization;
step (2): convert preprocessed source images from RGB space to YCbCr space through a channel-space conversion module; further input data of three channels into a pre-convolution module, which restructures data of each channel in channel dimension;
step (3): input images processed by the pre-convolution module into a multi-scale feature extraction module; encoding stage of the multi-scale feature extraction module comprises two encoding layers, operation of first encoding layer is expressed as follows:
$${x}_{11} = ResBlock ( {x}_{n} )$$
$${x}_{down 1} = {Skip}_{Conv} ( Concat ( {x}_{n} , HybridAttention ( Down ( {x}_{11} ) ) ) , HybridAttention ( Down ( {x}_{11} ) ) )$$
where xₙ represents the images processed by the pre-convolution module, ResBlock(⋅) denotes a residual operation, HybridAttention(⋅) represents a hybrid attention operation, Skip_{Conv}(⋅) denotes a skip operation with convolution applied, Down(⋅) denotes a downsampling operation, and Concat(⋅) denotes a concatenation operation;
operation of second encoding layer is expressed as follows:
$${x}_{12} = ResBlock ( {x}_{down 1} )$$
$${x}_{down 2}^{′} = {Skip}_{Conv} ( Concat ( {x}_{down 1} , HybridAttention ( Down ( {x}_{12} ) ) ) , HybridAttention ( Down ( {x}_{12} ) ) )$$
$${x}_{down 2} = {Skip}_{Conv} ( Concat ( {x}_{n} , {x}_{down 2}^{′} ) , {x}_{down 2}^{′} )$$
$${x}_{bottom} = ResBlock ( {x}_{down 2} )$$
where x_{bottom} denotes bottom-layer output of encoding stage;
the bottom-layer output generates features of different scales through two decoding operations, and the specific process is expressed as follows:
$${x}_{up 1} = {Skip}_{Conv} ( Concat ( {x}_{bottom} , HybridAttention ( Up ( {x}_{bottom} ) ) ) , HybridAttention ( Up ( {x}_{bottom} ) ) )$$
$${x}_{21} = {Skip}_{Res} ( Concat ( {x}_{12} , ResBlock ( {x}_{up 1} ) ) , ResBlock ( {x}_{up 1} ) )$$
$${x}_{up 2} = {Skip}_{Conv} ( Concat ( {x}_{21} , HybridAttention ( Up ( {x}_{21} ) ) ) , HybridAttention ( Up ( {x}_{21} ) ) )$$
$${x}_{22}^{′} = {Skip}_{Conv} ( Concat ( {x}_{bottom} , ResBlock ( {x}_{up 2} ) ) , ResBlock ( {x}_{up 2} ) )$$
$${x}_{22} = {Skip}_{Res} ( Concat ( {x}_{11} , {x}_{22}^{′} ) , {x}_{22}^{′} )$$
where x₂₁ and x₂₂ are two feature outputs of different scales in decoding process, Skip_{Res}(⋅) represents the Skip operation with residual applied, and Up(⋅) represents a upsampling operation;
after processing by the multi-scale feature extraction module, the source image yields three features, which are
$${F}_{n}^{2} = {x}_{22} , {F}_{n}^{1} = {x}_{21} , and {F}_{n}^{0} = {x}_{bottom}$$
in descending order of size;
step (4): combine features of three different scales corresponding to Y, Cb, and Cr channels in pairs and input into a filter prediction module; the filter prediction module employs spatial cross-attention to dynamically process two input feature maps
$${F}_{0}^{m} and {F}_{1}^{m}$$
at a same scale simultaneously, and assigns weights based on importance of each position, thereby outputting corresponding spatially attention-weighted feature maps; the specific operation is expressed as follows:
$$A = [ {A}_{0} , {A}_{1} ] = Sigmoid ( Conv ( ReLU ( Conv ( Concat ( {F}_{0}^{m} , {F}_{1}^{m} ) ) ) ) )$$
$$[ {F}_{0}^{m ′} , {F}_{1}^{m ′} ] = [ {F}_{0}^{m} ▯ {A}_{0} , {F}_{1}^{m} ▯ {A}_{1} ]$$
Where A is attention weight, A₀ and A₁ correspond to weight components of
$${F}_{0}^{m} and {F}_{1}^{m} , {F}_{0}^{m ′} and {F}_{1}^{m ′}$$
represent spatially attention-weighted feature maps corresponding to the input feature map
$${F}_{0}^{m} and {F}_{1}^{m} ,$$
m=0,1,2 denotes sequence number of different scales, [symbol] represents Hadamard product, Sigmoid(⋅) denotes Sigmoid activation function, and ReLU(⋅) denotes ReLU activation function;
the spatially attention-weighted feature map
$${F}_{0}^{m ′} and {F}_{1}^{m ′}$$
and the corresponding source image are inputted into a kernel prediction network based on a residual structure, respectively; during learning, the kernel prediction network predicts most effective filters
$${Filter}_{0}^{m} and {Filter}_{1}^{m}$$
through dynamic changes of
$${F}_{0}^{m ′} and {F}_{1}^{m ′} ,$$
the specific prediction operation of filter is expressed as follows:
kₙ^{m}=Conv(ReLU (Conv(Resblock(Fₙ^{m}′))))
Filterₙ^{m}=fold(sum(kₙ^{m}·Unfold(xₙ)))
where Unfold(⋅) denotes conversion of the source image into a column vector, fold(⋅) denotes reshaping of the feature map to its original size, sum(⋅) denotes summation operation,
$${k}_{n}^{m}$$
represents predicted convolutional kernel weight corresponding to
$${F}_{n}^{m ′} ;$$
the filter at the current scale Filter^{m}∈2×C×W×k² is obtained by adding the two filters, as shown in the following equation:
$${Filter}^{m} = {Filter}_{0}^{m} + {Filter}_{1}^{m}$$
step (5): input the Y, Cb, and Cr channel data of the two source images and filters of three different kernel sizes into a filtering fusion and adaptive enhancement module for convolution operations, and perform a weighted summation of the obtained convolution results to generate fused Y, Cb, and Cr channel datas, as shown in the following formula:
$${I}_{Y - fuse} = {\sum }_{i = 0}^{2} {α}_{0 , i} ( {Filter}_{Y}^{i} ⊗ Concat ( {I}_{Y - 0} , {I}_{Y - 1} ) )$$
$${I}_{Cb - fuse} = {\sum }_{i = 0}^{2} {α}_{1 , i} ( {Filter}_{Cb}^{i} ⊗ Concat ( {I}_{Cb - 0} , {I}_{Cb - 1} ) )$$
$${I}_{Cr - fuse} = {\sum }_{i = 0}^{2} {α}_{2 , i} ( {Filter}_{Cr}^{i} ⊗ Concat ( {I}_{Cr - 0} , {I}_{Cr - 1} ) )$$
where I_{Y-fuse}, C_{b-fuse} and I_{Cr-fuse} represent the fused results of the source image in the Y channel, Cb channel, and Cr channel; I_{Cb-0}, I_{Cb-1}, I_{Cr-0}, I_{Cr-1}, I_{Y-0}, and I_{Y-1} are the information of the YCbCr channels of the input source image; α is a training parameter in the network, ⊗ represents the convolution operation;
step (6): realize adaptive enhancement of the fused image by adjusting brightness and contrast factors of the Y channel, as well as saturation factors of the Cb and Cr channels during training process, to realize adaptive enhancement of the fused image; output enhanced data of the Y, Cb, and Cr channels and reconstruct to generate fused result, thus realizing unsupervised fusion of human soft tissue photoacoustic/ultrasound multimodal images.
